(19) United States
(12) Patent Application Publication
(10) Pub. No.: US 2013/0173834 A1
(43) Pub. Date: Jul. 4, 2013

(54) METHODS AND APPARATUS FOR INJECTING PCI EXPRESS TRAFFIC INTO HOST CACHE MEMORY USING A BIT MASK IN THE TRANSACTION LAYER STEERING TAG

(71) Applicants: Stephen D. Glaser, San Francisco, CA (US); Mark D. Hummel, Franklin, MA (US)

(72) Inventors: Stephen D. Glaser, San Francisco, CA (US); Mark D. Hummel, Franklin, MA (US)

(73) Assignee: ADVANCED MICRO DEVICES, INC., Sunnyvale, CA (US)

(21) Appl. No.: 13/341,557

(22) Filed: Dec. 30, 2011

(51) Int. Cl. G06F 13/28

(52) U.S. Cl. 710/308

(57) ABSTRACT

Methods and apparatus are provided for implementing transaction layer processing (TLP) hint (TPH) protocols in the context of the peripheral component interconnect express (PCIe) base specification. The method allows an endpoint function associated with a PCI Express device to configure a steering tag header in the open systems interconnect (OSI) transaction layer to identify a particular processing resource that the requester desires to target, such as a specific processor or cache location within the execution core. A bit mask may be implemented by the hardware or operating system, for example, by embedding the bit mask in the steering tag header. The bit mask provides administrative oversight of the steering tag header configuration, to thereby mitigate unintended denial of service attacks or cache misses occasioned by aggressive steering tag configuration strategies employed by endpoint functions.

### TECHNICAL FIELD

Embodiments of the subject matter described herein relate generally to mechanisms for implementing transaction layer processing hints in peripheral component interconnect express (PCIe)-compliant computing systems. More particularly, embodiments of the subject matter relate to the use of a bit mask in the steering tag header of the transaction layer to facilitate injecting PCIe traffic into host cache memory.

### BACKGROUND

PCI Express (peripheral component interconnect express), or PCIe, is the state of the art computer expansion card standard designed to replace the older PCI and PCI-X bus standards. Base specifications and engineering change notices (ECNs) are developed and maintained by the PCI special interest group (PCI-SIG) comprising more than 900 companies including Advanced Micro Devices, the Hewlett-Packard Company, and Intel Corporation. The PCIe bus serves as the primary motherboard-level interconnect for many consumer, server, and industrial applications, linking the host system processor with both integrated (surface mount) and add-on (expansion) peripherals.

The root complex associated with a typical PCIe-compliant system includes a central processing unit (CPU) core which cooperates with one or more cache memories to facilitate faster access to data, as opposed to retrieving data from system memory. Caches can reduce the average latency of device transactions by storing frequently accessed data in structures with significantly shorter latencies. However, cache memories are vulnerable to “capacity misses”, where the cache is too small to hold all the data requested by an application.

To make caches more effective and boost performance by reducing the average latency of memory loads, the PCI-SIG adopted a transaction layer processing (TLP) ECN in September, 2008 which provides TLP processing hints (TPHs) for use with PCIe base specification version 2.0. The TPH ECN is an optional normative protocol which defines a mechanism by which a device can provide hints on a transaction basis to enhance processing of requests targeting memory space.

The architected mechanisms enable association of system processing resources (e.g., caches) with the processing of requests from specific endpoint devices or functions. In this way, the TPH protocols allow the root complex and an endpoint communicating with it to improve transaction processing by effectively differentiating between: i) data which is likely to be re-used in the near future; and ii) bulk data that could overwhelm cache capacity and monopolize system resources.

The baseline TPH protocol defines various bits for use as processing hints, and bits for use as steering tags. The processing hints use certain reserved bits in the TLP header to indicate the communication usage models between an endpoint and the root complex. Certain additional bits in the TLP header are designated for use as steering tags, i.e., system specific values that provide information about the host or cache structure in the system cache hierarchy. Steering tags may thus be used to identify a particular processing resource that a requester desires to explicitly target. System software is configured to identify system level TPH capabilities and determine the steering tag allocation for each function that supports TPH.

Consequently, in a simplified THP usage model, a PCIe endpoint function may identify a particular processor within the execution core, and thereby facilitate placing data into the system cache hierarchy proximate that processor to reduce overall transaction latency.

The potential improvements in input/output (I/O) bandwidth and transaction processing latency associated with the TPH protocols are substantial. However, aggressive use of steering tags by a PCIe device can potentially overwhelm host processor cache capacity, and result in undesirable and unintended denial of service.

### BRIEF SUMMARY OF EMBODIMENTS

Various methods and corresponding structure for implementing transaction layer processing (TLP) hints in a central processing unit (CPU) memory complex are provided herein. An exemplary method implements a TLP processing hint (TPH) protocol in a CPU host having associated system memory, and includes managing a steering tag header in a transaction request message sent from a PCIe endpoint function to a central processing unit (CPU) complex, wherein the steering tag header embodies information relating to locations in the CPU complex targeted by the endpoint function. The method further includes processing, by the CPU complex, the steering tag header and thereby reconfiguring the targeted locations.

Also provided is an exemplary embodiment of a method of injecting PCIe input/output (I/O) traffic into a cache memory hierarchy associated with a root complex. The method includes receiving, at the root complex, a transaction request message sent from a PCIe endpoint function, where the message includes a TLP header having a processing hint portion and a steering tag portion. The method further includes reading, by the root complex, the steering tag portion to identify processing resource locations within the root complex targeted by the endpoint function and filtering, by the root complex, the targeted locations to reduce the number thereof. The method further includes embedding a bit mask in the steering tag portion, such that the filtering includes applying (i.e., operating) the bit mask upon the target locations, and further wherein the targeted locations include specific processors in root complex and/or specific cache memory structures within said cache memory hierarchy.

Also provided is an exemplary embodiment of a CPU complex configured to communicate with at least one PCIe endpoint function of the type including a requester module configured to implement an open systems interconnect (OSI) protocol stack and configured to send transaction request messages which include a steering tag header embodying information relating to processing resource locations in the CPU complex targeted by the endpoint function. The CPU complex includes a cache memory hierarchy having a plurality of last level cache memory sectors targetable by the at least one endpoint function; a receiving module configured to implement an OSI stack, to receive the transaction request messages from the endpoint function, and to read the steering tag header; a message processor configured to apply a bit mask to reconfigure the target processing resource locations communicated by the endpoint function to the CPU complex; and a memory controller configured to write data associated with one of the transaction request messages to at least one of the last level cache memory sectors in accordance with the reconfigured targeted locations.

The foregoing summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram representation of an exemplary embodiment of a processor system and associated PCIe I/O devices;

FIG. 2 is a schematic block diagram representation of an exemplary embodiment of a CPU/memory complex, which is suitable for use in the processor system shown in FIG. 1;

FIG. 3 is a schematic diagram representation of an exemplary embodiment of a TPL processing hint and steering tag header packet layout;

FIG. 4 is a flow chart that illustrates an exemplary embodiment of a method of managing a steering tag header in a PCIe compliant system; and

FIG. 5 is a flow chart that illustrates an exemplary embodiment of a method of injecting PCIe I/O traffic into a cache memory hierarchy associated with a root complex.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, logic elements, look-up tables, or the like, which may carry out a variety of functions under the control of one or more microprocessors or other control devices.

The subject matter presented here relates to methods and apparatus for implementing transaction layer processing (TLP) hint (TPH) protocols in the context of the peripheral component interconnect express (PCIe) base specification. The method allows an endpoint function associated with a PCI Express device to configure a steering tag header in accordance with the open systems interconnect (OSI) model to identify a particular processing resource that the requester desires to target, such as a specific processor or cache location within the execution core. A bit mask may be implemented by the hardware or operating system, for example, by embedding the bit mask in the steering tag header. The bit mask provides administrative oversight of the steering tag header configuration, to thereby mitigate unintended denial of service attacks or cache misses occasioned by aggressive steering tag configuration strategies employed by endpoint functions.

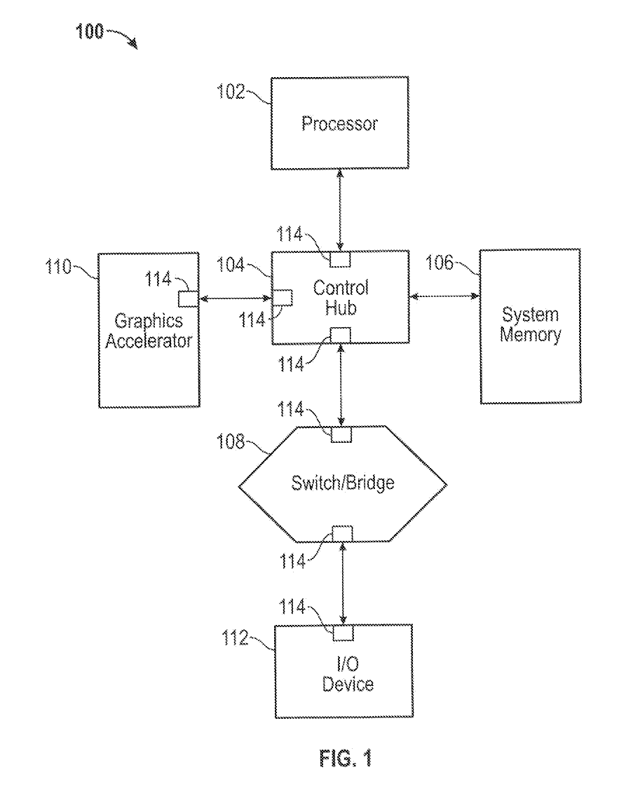

Referring now to the drawings, FIG. 1 is a schematic block diagram representation of an exemplary embodiment of a CPU/memory complex (processor system) 100. FIG. 1 depicts a simplified rendition of the CPU/memory complex 100, which may include a processor 102, a PCIe compliant controller hub 104 (also referred to as a root port or root complex) for connecting one or more PCIe end point devices 110 (e.g., a graphics controller), and a system memory 106 coupled to the processor 102, either directly or via controller hub 104. The system may also include an optional PCIe compliant switch/bridge 108 for connecting additional end point functions and/or devices such as, for example, one or more input/output (I/O) devices 112.

In the illustrated embodiment, one or more of controller hub 104, switch 108, and end point devices 110, 112 include respective I/O modules 114 configured to implement a layered protocol stack in accordance with, for example, the open systems interconnect (OSI) model. In an embodiment, I/O modules 114 facilitate PCIe compliant communication between and among processor 102, hub 104, switch 108, and devices 110 and 112.

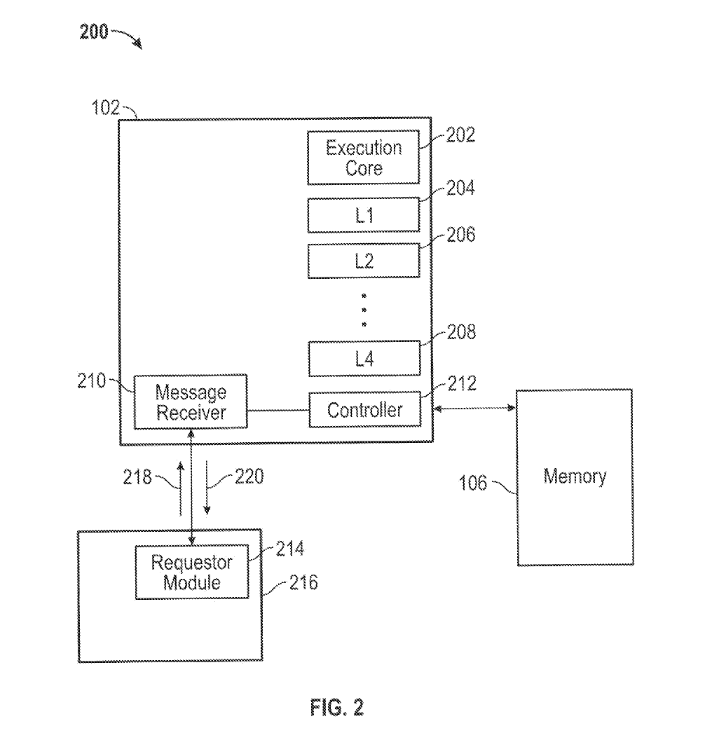

In the detailed embodiment shown in FIG. 2, the processor 102 may include, without limitation: an execution core 202; a level one (L1) cache memory 204; a level two (L2) cache memory 206; one or more further levels of cache memory (L4) 208; and a memory controller 212. The cache memories 204, 206, 208 are coupled to the execution core 202, and are coupled together to form a cache hierarchy, with the L1 cache memory 204 being at the top of the hierarchy and the L4 cache memory 208 being at the bottom. Those skilled in the art will appreciate that in the context of the embodiments described herein, cache memory sector 208 may be distributed within processor 102 and may also be referred to as “last level” cache, i.e., the bottom level of the cache hierarchy closest to system memory. The execution core 202 may represent a processor core that issues demand requests for data. Responsive to requests issued by the execution core 202, one or more of the cache memories 204, 206, 208 may be searched to determine if the requested data is stored therein, or data from an endpoint device or function may be written directly into a cache memory (particularly last level cache 208), as described below.

In one embodiment, the processor 102 may include multiple instances of the execution core 202, and one or more of the cache memories 204, 206, 208 may be shared between two or more instances of the execution core 202. For example, in one embodiment, two execution cores 202 may share the L4 cache memory 208, while respective instances of execution core 202 may have separate, dedicated instances of the L1 cache memory 204 and the L2 cache memory 206. Other arrangements are also possible and contemplated. Those skilled in the art will appreciate that PCIe compliant links are configured to maintain coherency with respect to processor caches and system memory as provided for in PCIe base specification version 3.0, which is available at http://www.pcisig.com/specifications/pciexpress.

The processor 102 also includes the memory controller 212 in the embodiment shown. The memory controller 212 may provide an interface between the processor 102 and the system memory 106, which may include one or more memory banks. The memory controller 212 may also be coupled to each of the cache memories 204, 206, 208. More particularly, the memory controller 212 may load cache lines (i.e., blocks of data stored in system memory) directly into any one or all of the cache memories 204, 206, 208. In one embodiment, the memory controller 212 may load a cache line into one or more of the cache memories 204, 206, 208 responsive to a request by the execution core 106. A cache line may be loaded into one of the cache memories from system memory 106, or may be injected into the cache hierarchy directly from one of the I/O devices 110, 112, and 216.

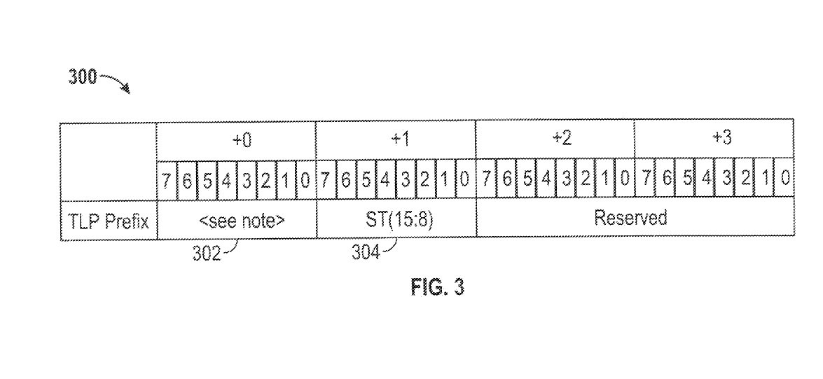

As briefly discussed above, the TLP processing hints (TPH) protocol enables cache lines to be injected directly into the cache hierarchy from an I/O device without necessarily having to be first written to and retrieved from system memory. With continued reference to FIG. 2, processor 102 is configured to communicate with a PCIe compliant endpoint device (or function) 216. To facilitate directing data from device 216 into the host memory cache hierarchy in accordance with the aforementioned PPH protocols, endpoint device 216 includes an I/O module 214, referred to in FIG. 2 as a requester module 214, and processor 102 includes an I/O module 210, referred to in FIG. 2 as a message receiver 210. Requester module 214 is a client subsystem that sends transaction requests (e.g., read/write requests) 218 to processor 102, and receives transaction confirmation messages 220 from processor 102. Message receiver module 210 and requester module 214 may be implemented as part of an I/O module configured to implement an OSI protocol stack. Thus, transaction request messages 218 suitably include a TLP header, described in more detail in connection with FIG. 3.

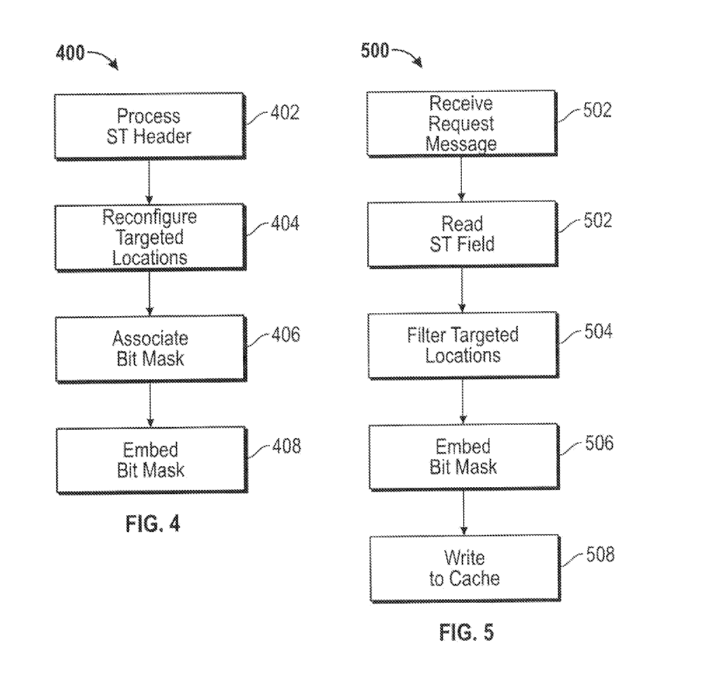

The processor system 100 may be configured to operate in the manner described in detail below. For example, FIG. 4 is a flow diagram illustrating an exemplary embodiment of a method for implementing TPH protocols to inject PCIe traffic into a host memory cache hierarchy, which may be performed by the processor system 100. The various tasks performed in connection with processes described here may be performed by software, hardware, firmware, or any combination thereof. For illustrative purposes, the description of a process may refer to elements mentioned in connection with the various drawing figures. In practice, portions of a described process may be performed by different elements of the described system, e.g., the execution core 202, memory controller 212, controller hub 104, message receiver 210, requester module 214, or other logic in the system.

It should be further appreciated that a described process may include any number of additional or alternative tasks, the tasks shown in the figures need not be performed in the illustrated order, and that a described process may be incorporated into a more comprehensive procedure or process having additional functionality not described in detail herein. Moreover, one or more of the tasks shown in the figures could be omitted from an embodiment of a described process as long as the intended overall functionality remains intact.

Referring now to FIG. 3, an exemplary TLP header 300 in accordance with the PCI-SIG TLP processing hints ECN (adopted Sep. 11, 2008) is shown. TLP header 300 includes a processing hints portion 302 and a steering tag portion 304. The processing hints portion 302 indicates the communication usage model to be used by the PCIe endpoint function to communicate with the root complex. Steering tag portion 304 of TLP header 300 may be used to determine whether a PCIe read or write should be retained in the last level cache, for example, by explicitly targeting (e.g., identifying) one or more processing resources (e.g., processors or host memory cache locations). In an embodiment, processing hints portion 302 comprises two bits, and ST portion 304 comprises 8 bits.

In this regard, most cache systems are set associative. In an N-way set associative cache, each cacheable entity can reside in the cache in up to N distinct locations. To look up an entity in the cache, the appropriate location in every set is probed simultaneously and that result is then matched in parallel. When a new item is added to the cache, only other items in the same set are usually considered when choosing an entity for eviction.

To mitigate this denial of service/performance interaction problem, in one embodiment, the value of steering tag portion 304, in conjunction with the requesting device ID, can be used to determine which sectors or specific locations within the cache hierarchy (e.g., last level cache) are permitted to contain elements (data) from the requesting device. This can provide full isolation or varying degrees of coupling between devices.

In one exemplary embodiment, the ST field (steering tag portion 304) may be configured as a bit mask when populating the host cache. When a cache miss occurs, the ST bits may be used to determine cache locations are to be considered when placing the new cache entry. If the ST bit is 1b, the associated cache set is considered. If an empty item occurs in the set, that entry may be filled, provided that the cache state is adjusted so that the data maintains its existing eviction priority.

In more complex embodiments, the ST value may be used to determine cache placement at a smaller granularity than the associativity set. As an example, the ST value may be configured to indicate that, for a cache miss requiring eviction, the new entity is assigned a predetermined probability (e.g., 50%) of evicting an item from one or more of the selected associativity sets.

In embodiments where the ST field forms a bit mask, the bit mask may be used to mitigate unintended consequences of aggressive use of the ST field by a PCIe function. Conceptually, a bit mask is a device or technique used to perform a bitwise (i.e., on a bit-by-bit basis) operation (typically the binary AND operation) on a series of binary values (bits). In practice, a bit mask is a string of bits (1's and 0's) which is ANDed, on a bit-by-bit basis, with a string of data. When the binary value “1” in the mask is ANDed with any data bit, the operation yields that data bit. When the binary value “0” in the mask is ANDed with a data bit, the operation produces a “0”.

When a PCIe device vendor configures the ST header to select desired cache destinations in accordance with, for example, the PCI-SIG TPH protocol, all the selected destinations are initially valid in the absence of a bit mask. When a bit mask is introduced, for example when the operating system or hardware embeds or superimposes a bit mask into the ST header, the bit mask functions to override, or surgically refine, the original ST header configuration.

Where the hardware or operating system selects a 1 for a particular bit position, the original bit designation selected by the device is preserved, i.e., it survives application of the bit mask. For each bit position in which the hardware or operating system selects a 0, the original bit designation selected by the device is over-ridden or nullified. Consequently, embedding a bit mask in the ST header redefines the original ST designation and effectively recasts the requested cache destinations in an “up to and including” (or “less than or equal to”) manner.

For example, suppose that three cache locations, namely ABC, are originally selected. Application of the bit mask results in one of the following eight possible sets (combinations and sub-combinations) of cache locations, depending on the configuration of the mask: i) A; ii) AB; iii) ABC; iv) AC; v) B; vi) BC; vii) C; and viii) [empty].

FIG. 4 is a flow chart that illustrates an exemplary embodiment of a method 400 of managing a steering tag header in a transaction request message from a PCIe endpoint function, wherein the steering tag field includes information relating to locations in the associated CPU complex targeted by the endpoint function, in accordance with various embodiments. The method 400 includes processing (task 402), by the CPU complex, the steering tag header, and reconfiguring (task 404) the locations targeted by the endpoint. In an embodiment, the number of processing resource locations (e.g., specific processors or cache sectors in the cache hierarchy) initially targeted by the endpoint is reduced by the host.

Method 400 further includes associating (task 406) a bit mask with the ST header, and applying the bit mask to the information in the ST header. In an embodiment, the bit mask may be associated with the ST header by embedding it (task 408) in the TLP header, for example, by embedding it in the ST field 304.

FIG. 5 is a flow chart that illustrates an exemplary embodiment of a method 500 of injecting PCIe I/O traffic (data) into a cache memory hierarchy associated with a root complex. The method 500 includes receiving (task 502), at the root complex, a transaction request message sent from a PCIe endpoint function, wherein the message includes a TLP header having a processing hint portion and a steering tag portion. The method 500 includes reading (task 504) the ST field to identify the locations of processing resources targeted by the endpoint function, and filtering (task 506) the information in the ST field to reduce the number of candidate cache locations.

The method 500 further includes embedding (task 508) a bit mask in the steering tag, such that the foregoing filtering operation may involve operating (applying) the bit mask upon the targeted locations (e.g., specific processors associated with the root complex and/or specific memory structures or locations/sectors in the cache memory hierarchy)

Having filtered the initially targeted locations, for example, by applying the bit mask, process 500 writes (task 510) the subject I/O data to the desired cache memory location.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of managing a steering tag header in a transaction request message sent from a PCIe endpoint function to a central processing unit (CPU) complex, the steering tag header embodying information relating to locations in the CPU complex targeted by the endpoint function, the method comprising:
processing, by said CPU complex, said steering tag header; and
reconfiguring, as a result of said processing, said targeted locations.

2. The method of claim 1, wherein reconfiguring said targeted locations comprises reducing the number of said targeted locations.

3. The method of claim 1, wherein said CPU complex has an associated cache memory hierarchy, and said targeted locations are in said cache memory hierarchy.

4. The method of claim 1, further comprising associating a bit mask with said steering tag header, and further wherein processing comprises applying said bit mask to said information relating to said locations.

5. The method of claim 4, wherein associating a bit mask comprises embedding said bit mask in said steering tag header.

6. The method of claim 5, wherein said bit mask is configured to implement the binary AND function.

7. The method of claim 1, wherein said transaction request message includes a transaction layer processing (TLP) header configured in accordance with the open systems interconnect (OSI) model, and said TLP header comprises said steering tag header.

8. The method of claim 7, wherein said steering tag header comprises 8 bits.

9. The method of claim 8 further comprising embedding a bit mask in said steering tag header, and wherein processing said steering tag header comprises operating said bit mask upon said information relating to said targeted locations.

10. The method of claim 9, wherein said reconfiguring comprises reducing the number of said targeted locations as a result of operating said bit mask.

11. The method of claim 10, wherein said CPU complex includes an execution core including a cache memory hierarchy within which said targeted locations are located.

12. The method of claim 11, wherein said TLP header further embodies information relating to TLP processing hints.

13. The method of claim 1 wherein said targeted locations correspond to specific processors within said CPU complex.

14. The method of claim 1 wherein said targeted locations correspond to memory cache sectors within said CPU complex.

15. A method of injecting PCIe input/output (I/O) traffic into a cache memory hierarchy associated with a root complex, the method comprising:
receiving, at said root complex, a transaction request message sent from a PCIe endpoint function, said message including a TLP header comprising a processing hint portion and a steering tag portion;
reading, by said root complex, said steering tag portion to identify processing resource locations within said root complex targeted by said endpoint function; and
filtering, by said root complex, said targeted locations to reduce the number thereof.

16. The method of claim 15, further comprising embedding a bit mask in said steering tag portion, wherein filtering comprises operating said bit mask upon said targeted locations.

17. The method of claim 16, wherein said targeted locations comprise specific processors in said root complex.

18. The method of claim 16, wherein said targeted locations comprise cache memory structures within said cache memory hierarchy.

19. The method of claim 18, further comprising writing data associated with said I/O traffic to a filtered location within said cache memory hierarchy.

20. A CPU complex configured to communicate with at least one PCIe endpoint function of the type including a requester module configured to implement an open systems interconnect (OSI) protocol stack and configured to send transaction request messages which include a steering tag header embodying information relating to processing resource locations in the CPU complex targeted by the endpoint function, the CPU complex comprising:
a cache memory hierarchy comprising a plurality of last level cache memory sectors targetable by the at least one endpoint function;
a receiving module configured to implement an OSI stack, to receive the transaction request messages from the endpoint function, to read the steering tag header, and to apply a bit mask to reconfigure the target processing resource locations communicated by the endpoint function to the CPU complex; and
a memory controller configured to write data associated with one of the transaction request messages to at least one of said last level cache memory sectors in accordance with said reconfigured targeted locations.
